(19) United States
(12) Patent Application Publication
(10) Pub. No.: US 2011/0168651 A1
(43) Pub. Date: Jul. 14, 2011

(54) Shelving System and Components Thereof

(75) Inventors: Mark E. Stenftenagel, Elmhurst, IL (US); Salvatore S. Graziano, Western Springs, IL (US); Otto B. Schieber, Chicago, IL (US); Rick K. Joutras, Naperville, IL (US)

(73) Assignee: Demco, Inc., Madison, WI (US)

(21) Appl. No.: 12/686,462

(22) Filed: Jan. 13, 2010

(51) Int. Cl. A47B 65/00; F16M 11/04; A47F 5/00

(52) U.S. Cl. 211/42; 248/121; 211/153

(57) ABSTRACT

A shelving system and components thereof is disclosed. Preferably, the shelving system is a reverse cantilever shelf mounting system, wherein one or more shelves are supported by and extend rearwardly from an inner face of upright vertical standards. The vertical standards are of two piece construction having a triangular cross-sectional shape and an inner face having vertically oriented slots along its length for mounting shelf brackets. Tensioned cross braces lock together welded side frames of the shelving system. A base facia or “kick plate” panel may be mounted to the base of the shelving system frame, and optional open-sided rod bookstops mate with punched out mounts that are integral with the shelf top surface to securely mount the bookstop to the shelf.

### FIELD OF THE INVENTION

The present application relates generally to a shelving system and to components thereof.

### BACKGROUND

Shelving systems for the storage and display of various objects are found in a wide variety of industrial and domestic locations, libraries, schools and offices, and have utility in many different applications. Shelving systems are also found in a variety of differing designs and configurations. Examples of various shelving systems may be found in one or more of the following U.S. Pat. Nos. 1,560,122 to Vance, 6,814,245 to Leclerc et al., 5,279,231 to Kolvites et al., and 7,406,920 to Scholz, among others.

### SUMMARY

The subject matter described herein is directed to a novel shelving system and components thereof that may find application in the illustrated as well as other shelving systems.

In accordance with one aspect of the subject matter described herein, a reverse cantilevered shelf mounting system is provided. The shelf mounting system preferably comprises an upright vertical standard for supporting a plurality of horizontal shelves. The standard has an inwardly facing surface and an outwardly facing surface. A shelf is cantilever-supported by the inwardly facing surface of the standard, and extends inwardly therefrom, terminating at a free inner edge.

In accordance with another aspect of the subject matter described herein, a two piece shelf support standard is provided. The standard preferably comprises a first elongated member and a second elongated member that is substantially co-extensive with the first elongated member. The first and second members together define an upright shelf support standard having a generally triangular cross-sectional shape. The standard has a first surface facing in a first direction and a second surface facing in a direction opposite to the first. A plurality of shelf mounting apertures are defined in the second surface.

In accordance with a still further aspect of the subject matter described herein, a shelving system is provided. The shelving system preferably comprises a first frame structure having a top end and a bottom end and a second frame structure having a top end and a bottom end. A first horizontal member extends between the first and second frame structures proximal to the top end, and a second horizontal member extends between the first and second frame structures proximal to the bottom end. A first tension member extends between a first location on the first frame structure to a first location on the second frame structure, and a second tension member extends between a second location on the second frame structure to a second location on the first frame structure. The first locations are vertically spaced apart and the second locations are vertically spaced apart. The first and second tension members exert tension to securely connect the first and second frame structures together.

In accordance with another aspect of the subject matter described herein, a bookshelf and bookstop combination is provided. The combination preferably comprises a one-piece shelf comprising a top surface and a first raised mounting aperture defined above the surface and further comprises a bookstop defined by an open wire frame. A mounting portion of the wire frame is removably receivable within the mounting aperture to secure the bookstop to the shelf.

In accordance with a still further aspect of the subject matter described herein, a shelving system is provided. The shelving system preferably comprises at least a pair of spaced-apart front vertical shelf support standards, at least a pair of spaced-apart rear vertical shelf support standards, and at least a pair of cross rails, each cross rail extending between and connecting a front standard and a rear standard proximal to a lower end of the standards. The system also preferably comprises a fascia panel having a first end and a second end for mounting between the front vertical standards proximal to the lower end of the standards. The panel has a mounting surface at each end, and each of the cross rails is cooperative with the respective mounting surfaces for permitting removable mounting of the panel between the cross rails.

Various other features and advantages of the subject matter of the present application are set forth in the following description and drawings, as well as in the appended claims.

### BRIEF DESCRIPTION OF THE DRAWINGS

FIG. 1 is a perspective view of one embodiment of a shelving system, partially broken away.

FIG. 2 is an enlarged perspective view of one embodiment of separate elongated members that together form a two-piece upright vertical shelf support standard of the shelving system shown in FIG. 1.

FIG. 3 illustrates the elongated members of FIG. 2 joined together defining one embodiment of an upright vertical shelf support standard having a generally triangular cross-sectional shape and a plurality of shelf mounting apertures defined in one surface of the standard.

FIG. 4 is a side perspective view of one embodiment of a shelf mounting bracket cantilever-supported to the vertical shelf support standard illustrated in FIG. 3.

FIG. 5 is an enlarged perspective view of the assembly of horizontal and vertical members of the frame structure in the shelving system of FIG. 1.

FIG. 6 is a perspective view of the underside of one end of a horizontal shelf supported by a bracket reverse cantilever mounted to an inwardly facing surface of a front vertical standard of the shelving system of FIG. 1.

FIG. 7 is an enlarged perspective view of the assembly of a top center portion of the frame structure of the shelving system of FIG. 1.

FIG. 8 is a vertical cross-sectional view of the assembly of a top center portion of the frame structure of the shelving system illustrated in FIG. 7, taken along line 8-8.

FIG. 9 is a vertical cross-sectional view of a top center portion of a frame structure upon completion of the assembly illustrated in FIGS. 7 and 8, taken along line 8-8 of FIG. 7.

FIG. 10 is a perspective view of the underside of one embodiment of a top center portion of the frame structure of the shelving system shown in FIG. 1.

FIG. 11 is an enlarged perspective view of a bottom end portion of the frame structure of the shelving system of FIG. 1.

FIG. 12 is a vertical cross-sectional view of the assembly of shelving system frame components shown in FIG. 11, taken along line 12-12.

FIG. 13 is an enlarged perspective view of an end portion of the frame structure of the shelving system of FIG. 1.

FIG. 14 is an enlarged perspective view illustrating the mounting of base fascia panels to the frame of the shelving system of FIG. 1.

FIG. 15 is an enlarged perspective view showing base fascia panels removably mounted to the shelving system frame.

FIG. 16 is a perspective view of one embodiment of an open wire frame bookstop removably mounted to apertures raised above a shelf top surface.

### DETAILED DESCRIPTION

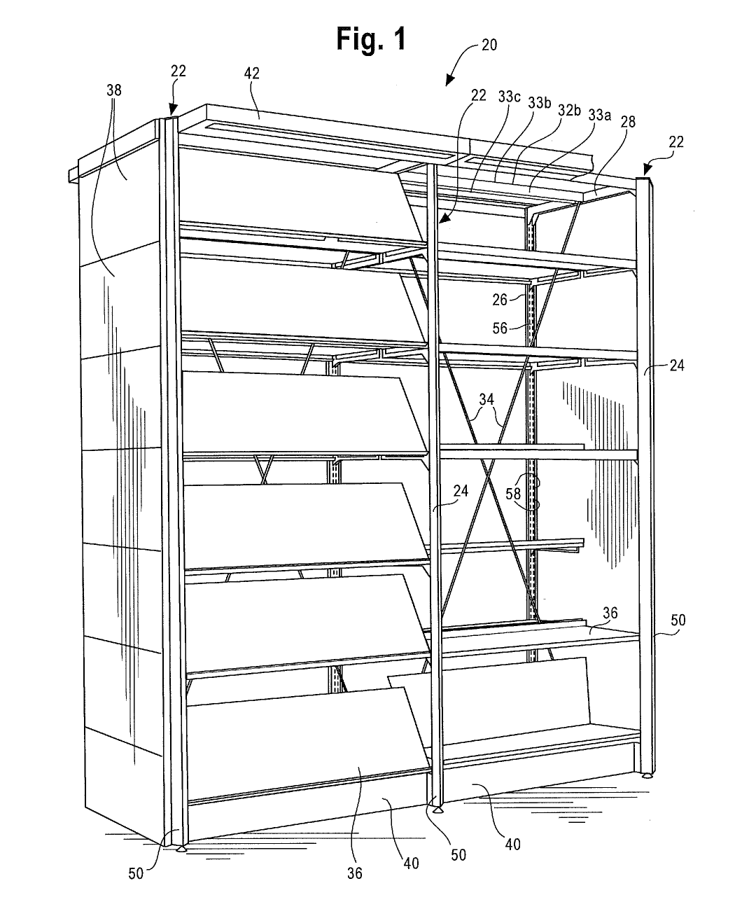

FIG. 1 generally illustrates a shelving system 20 which may be utilized in a variety of applications, including, but not limited to libraries, schools, homes and/or offices. In one example, the shelving system 20 may be used for the storage and display of an assortment of objects, such as books, magazines, files and the like. As shown in FIG. 1, the shelving system 20 may be free standing and does not require the additional support of a vertical surface such as a wall. Of course, the shelving system 20 can be placed in any location or arrangement as desired by the user, and may, if desired, be placed with one or more sides adjacent to a wall or other object. As a free-standing structure, the shelving system can be approached by a user from both the front and the back sides, thereby increasing the amount of accessible and usable storage space. This is especially beneficial in a library or school setting when large numbers of books and other types of literature or media must be stored and displayed in a limited space.

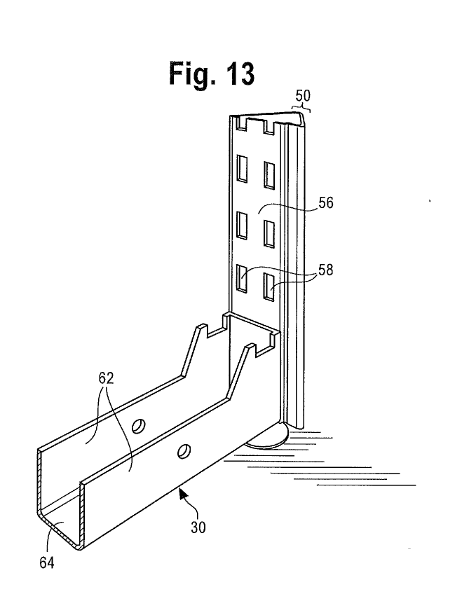

As shown in FIG. 1, the illustrated shelving system 20 includes a plurality of upright end and an intermediate frames, generally at 22. A single shelving unit would employ a pair of frame structures 22, but additional frame sections may be added depending on the length of the shelving assembly desired. Each frame structure 22 preferably includes two spaced-apart vertical standards including a front and a rear vertical standard 24 and 26, respectively. Note that for purposes of this description, “front,” “rear,” “inwardly,” “outwardly,” “left” and “right” are used to denote relative positioning or location only. The front and rear vertical standards 24, 26 are attached by upper and lower horizontal cross rails 28 and 30, that are preferably welded or otherwise fixedly attached to the vertical standard, as shown, for example, in FIGS. 1, 10, 11, and 13-15.

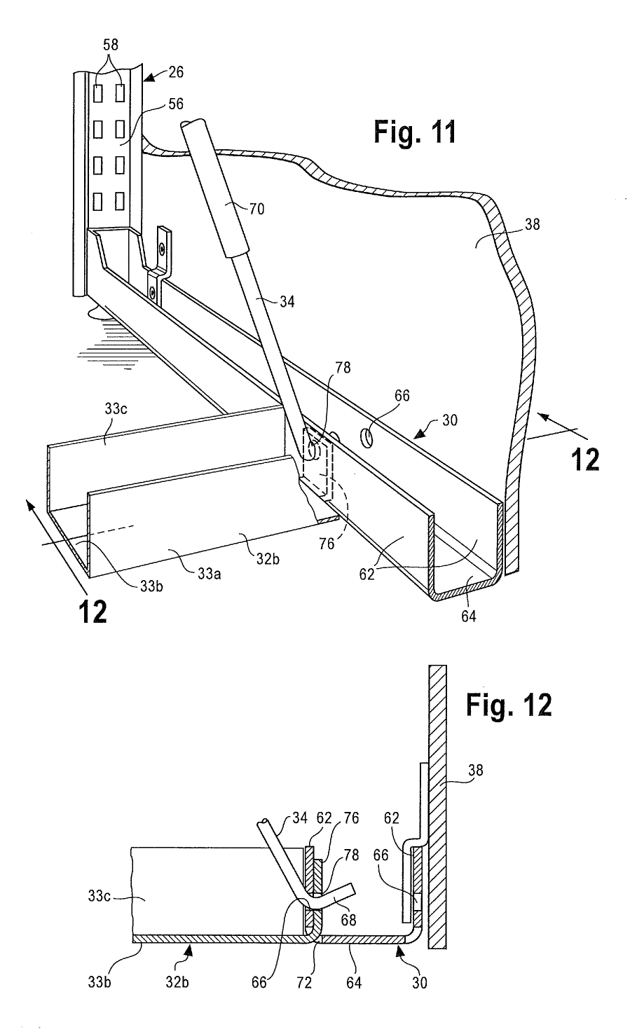

As discussed in more detail later, the frame structures 22 are joined by upper and lower horizontal members 32a, 32b and 32c, as shown in FIGS. 1, 10 and 11, and diagonal tension cross-members or rods 34, shown partially in FIGS. 1 and 7-12. A plurality of shelves 36 are reverse cantilever-supported by the vertical standards 24, 26. The shelving system may also include end panels 38, a base facia or “kick plate” panels 40 and overhead lighting fixtures 42.

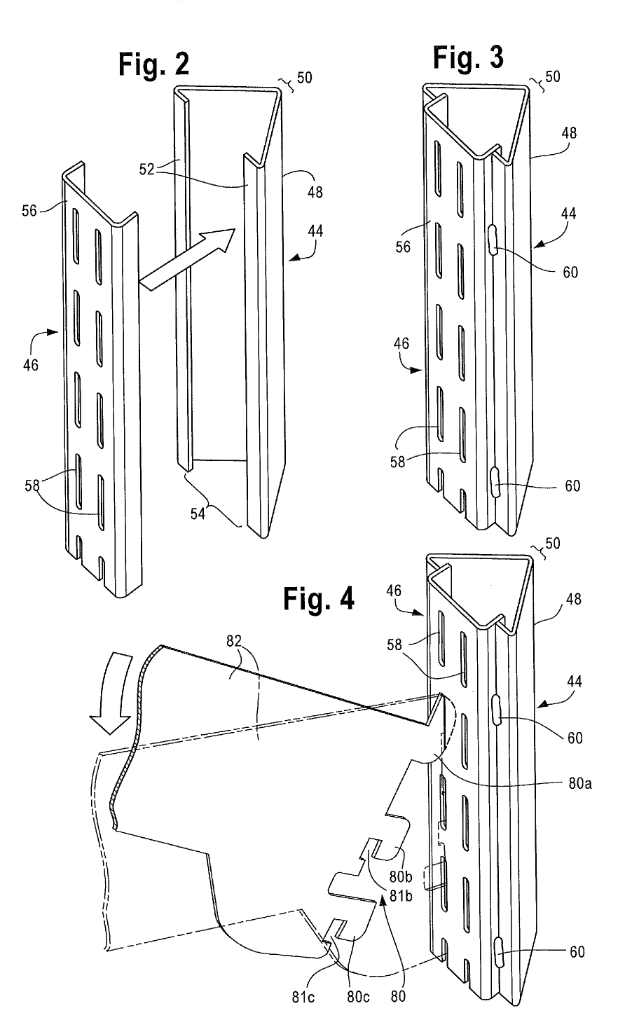

As previously mentioned, each frame 22 includes front and rear vertical standards 24, 26 joined by upper and lower horizontal rails 28, 30. In the embodiment shown generally in FIG. 2, each of the upright vertical standards 24, 26 are of at least a two-piece construction, and have a first elongated member 44 and a second elongated member 46 that is generally of the same length, i.e. co-extensive with the first elongated member. Although the shape may differ (e.g., rectangular or square) in the embodiment illustrated in FIG. 2, the first elongated member 44 defines two sides of a generally triangular cross-sectional shape, wherein the two sides join together at a vertex 48. The vertex 48 of the first elongated member 44 defines a first or outwardly facing decorative angled surface, generally at 50, which decorative angled surface faces forwardly or outwardly, in the direction of a user approaching the shelving system 20. The remaining side 52 of the first member 44 has facing, spaced apart edges that define an elongated opening or slot 54 which preferably extends substantially the entire length of the first member 44.

The second elongated member 46 is preferably generally U-shaped and mounted within the elongated slot 54, and the elongated members 44, 46 fixedly attached together, as illustrated in FIG. 3, such as by welding 60. Other means of attachment of members 44, 46 are also contemplated, including adhesives to the extent that such attachment means have sufficient strength to form a high strength joinder and fixedly attach the first and second elongated members. The first and second elongated members 44, 46 together define an upright vertical shelf support standard, as illustrated in FIG. 3, having a generally triangular cross-sectional shape. It will be appreciated that the above-described two-piece construction can also be used with other shaped upright vertical standards, including, but not limited to square, circle and/or oval.

The second elongated member 46 defines a second surface 56 of the standard, which faces in a direction opposite to the first surface 50. That is, the second surface 56 faces inwardly, or away from a user approaching the shelving system, toward the interior of the system 20. Thus, the inwardly facing surfaces 56 of the front and rear vertical standards 24, 26 face each other. As shown in FIG. 3, the inwardly facing surface 56 of the second elongated member 46 has a plurality of shelf mounting apertures 58 defined therein, which apertures 58 preferably extend substantially along the length of the second member. In the illustrated embodiment of FIGS. 2-4, the apertures are side by side pairs of elongated slots and the pairs are spaced apart along the standard for selective shelf bracket locations.

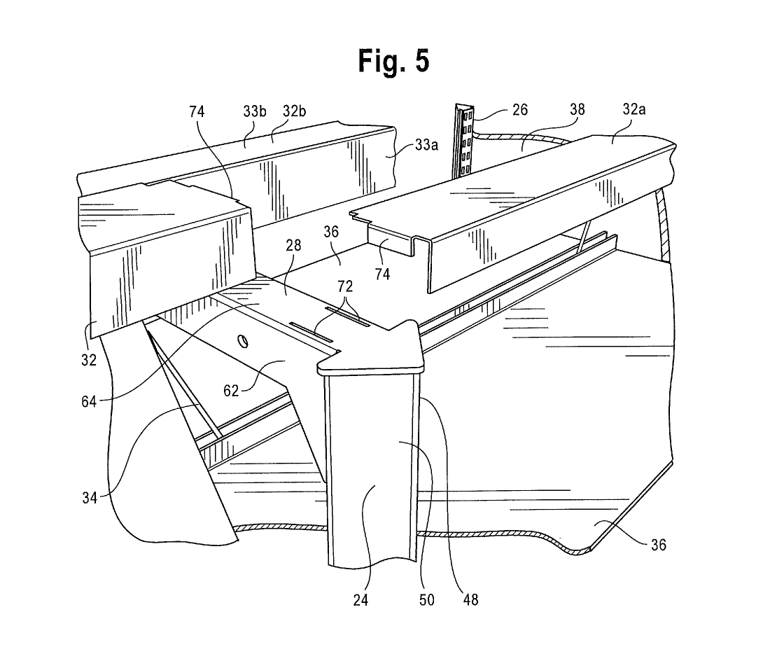

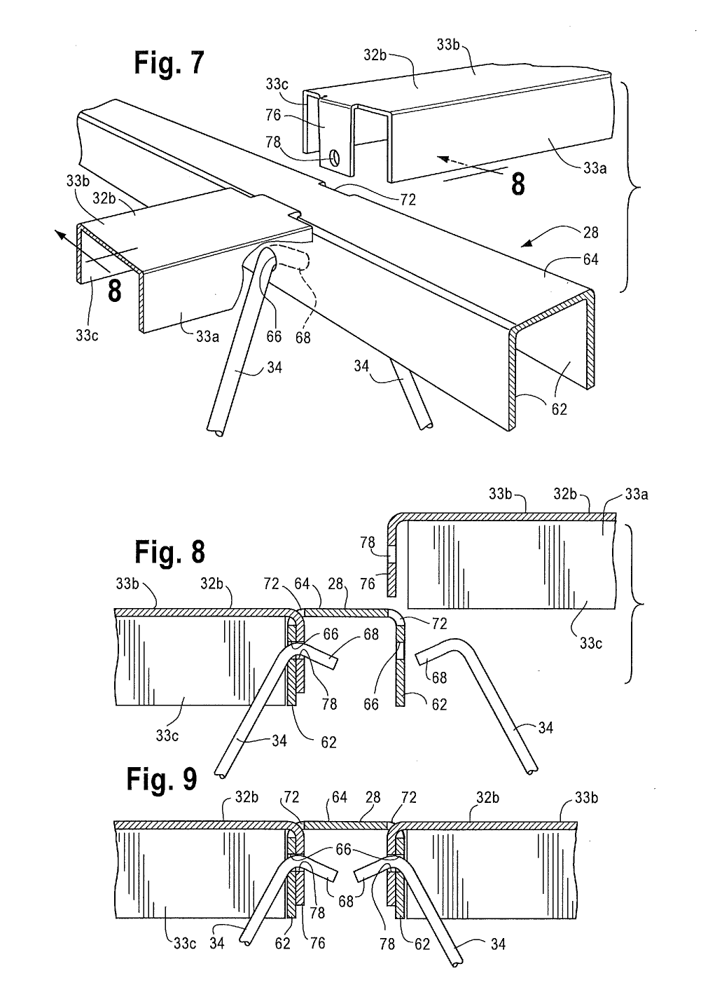

As illustrated partially in FIGS. 5 and 10-12, for example, the front and rear vertical standards 24, 26 of each frame structure 22 are joined by upper and lower horizontal cross rails 28, 30. The cross rails extend between the respective vertical standards 24, 26 and are welded or otherwise fixedly attached to the inwardly facing surface 56 of the respective vertical standards. As illustrated in exemplary FIGS. 7-9 and 11, the horizontal cross rails 28, 30 are generally U-shaped, with parallel vertical side walls 62 and a third wall 64 connecting the vertical side walls 62, thus forming a generally U-shaped cross sectional shape.

As shown in FIGS. 7-9 and 11-12, the upper and lower horizontal cross rails 28, 30 may include a tensioning aperture 66 in one or more of the vertical side walls 62. The tensioning aperture 66 is sized and shaped to receive one end 68 of tension member 34. In the illustrated embodiment shown in FIG. 7, one end 68 of the diagonal tension cross-members 34 has been inserted through the aperture 66 of upper horizontal cross rail 28. The end of the cross-member is L-shaped and the angled end secures the end of the tension member within the aperture. Similarly, as shown in FIG. 11, the other end 68 of tension member 34 has been inserted through aperture 66 of the lower horizontal cross rail 30 of the adjoining frame 22, and is similarly bent at a right angle to secure the end of the tension member within the aperture when under tension. In addition to mating aperture 66, it will be appreciated that the diagonal tension cross members can also be fixedly attached to or otherwise secured to the horizontal cross rails in a variety of other ways, including by welding, screws or the like.

As shown partially in FIG. 1, it is preferable that two diagonal tension members 34 extend between two frame structures 22, thereby forming an “X” configuration between the frames. That is, one tension member extends from a top end of one frame structure 22 to the bottom end of a second frame structure 22, such as the adjoining frame structure. Likewise, a second tension member 34 extends from the top end of the second frame structure 22 to the bottom end of the first frame structure 22. The tension members 34 exert tension to securely connect the frame structures 22 together. In the illustrated and preferred embodiment, the tension members are secured proximal to the top and bottom ends the frame structures 22, however, alternative configurations are also contemplated. For example, in another configuration, tension members 34 may be secured to the frame structures 22 at various points that are vertically spaced from the top and bottom ends of the frame. Preferably, at least one of the tension members has an adjustable length. FIG. 11 illustrates a portion of tension member 34 having two sub-members coupled by turnbuckle 70 for adjusting the length of the tension member 34.

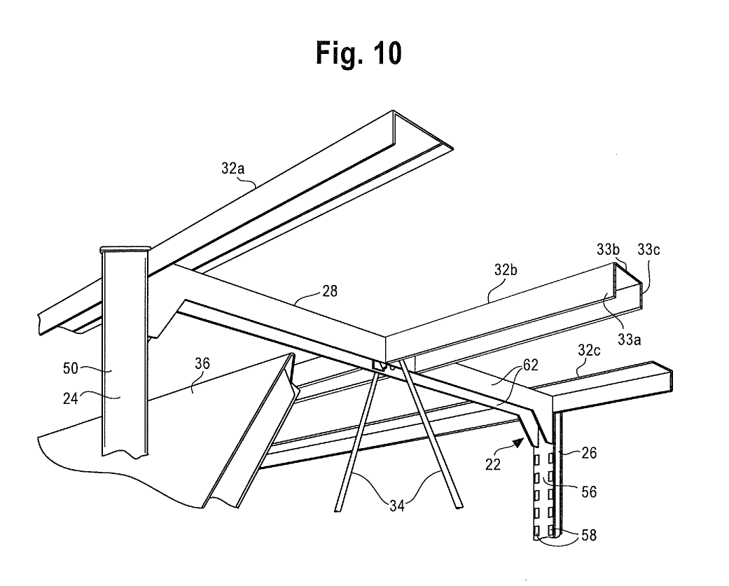

As also seen partially in FIG. 1 and in further detail in FIG. 5, the illustrated shelving system 20 also includes a plurality of horizontal members 32a, 32b and 32c extending between and connecting the upper and lower horizontal cross rails 28, 30, to secure together the frames 22. As shown in FIG. 10, the top end of the shelving system preferably includes three horizontal members 32 connected to the top horizontal cross rail 28, including one in the front 32a, one in the rear 32c, and one therebetween 32b. The bottom end of the shelving system, as illustrated in FIG. 11, for example, preferably includes at least one horizontal member 32b extending between and connecting to the lower horizontal cross rails 30. However, it is also contemplated that more or fewer horizontal members 32 may be used to connect the horizontal cross rails at the top and/or bottom of the shelving system 20.

As illustrated in FIG. 5, the upper horizontal cross rail 28 preferably includes a plurality of spaced apart elongated slots 72 defined therein. The slots are sized and shaped to cooperate with a downwardly extending tab or lip 74 located on the ends of the front and rear horizontal members 32a and 32c. The tab 74 is inserted into one of the elongated slots 72 to removably secure the horizontal members 32a and 32c to the horizontal cross rail 28. The horizontal members between the cross rails provide rigidity to the shelving system when tension is applied by the cross members 34.

Similarly, FIG. 7 illustrates a center horizontal member 32b at the top end of the shelving system, while FIG. 11 illustrates a center horizontal member 32b at the bottom end of the system 20. The center horizontal members 32b have a slightly different construction than the front and rear horizontal members 32a and 32c shown in FIG. 5 and described above. In the illustrated embodiment of FIGS. 7-12, the center horizontal members 32b at the top and bottom of the shelving system 20, respectively, are generally U-shaped, with parallel vertical side walls 33a and 33c and a third horizontal wall 33b connecting the vertical side walls 33a, 33c, thus forming a generally U-shaped cross sectional shape. The end portion of center horizontal members 32b also preferably includes an elongated tab 76. Preferably, tab 76 has an aperture 78 defined therein. As shown in FIGS. 7, 8 and 12, tab 76 is inserted into one of the elongated slots 72 defined in the middle portion of upper and lower horizontal cross rails 28, 30. Preferably, as shown in exemplary FIGS. 7-9, the surface of third wall 33b of the horizontal member 32b is generally level with the surface of third wall 64 of the horizontal cross rails 28, 30. When tab 76 is inserted into slot 72, aperture 78 in the tab aligns with aperture 66 in the cross rail vertical wall 62. One end 68 of tension member 34 is then preferably inserted through both apertures 66, 78, and at least one of the tension members tightened, if necessary, thereby securely locking the frames 22 together.

Turning back to the shelving system 20 illustrated in FIG. 1, a general view of the reverse cantilevered shelving system is shown. In a reverse cantilevered shelving system, one or more shelves 36 are supported by and extend inwardly from the inward facing surface 56 of the upright vertical standards 24, 26 and terminate at free inner edges that are not supported by a standard or a cross member 34, therefore extending inwardly in a cantilever manner from the inward facing side 56 of the vertical standard. This may be contrasted with the typical forward cantilever mounting of shelves to rear standards.

The shelves 36 can be mounted horizontally, or parallel to the floor to display items such as books, or alternatively, at an angle, such as approximately 45° to the floor or any other suitable angle to display the contents of the shelves. More specifically, FIG. 1 illustrates one or more shelves 36 that extend between at least two frame structures 22, the shelves 36 being reverse cantilever mounted to the upright vertical standards of the respective frames 22. As shown in FIG. 1, a plurality of generally horizontal shelves are cantilever-supported by inwardly facing surfaces 56 of the front vertical standards 24, the shelves being free of vertical support by a rear vertical standard 26 or structure. Likewise, as also illustrated in FIG. 1, the shelving system 20 may further include one or more shelves cantilever supported by the inwardly facing surfaces 56 of the rear vertical standards 26. Shelves that are cantilever supported by the rear vertical standards 26 are free of vertical support from a front vertical standard 24 or structure.

The plurality of shelves 36 of shelving system 20 illustrated in FIG. 1 preferably have substantially the same width and depth. The front and rear vertical standards 24, 26 are horizontally spaced apart by a distance that is approximately twice the depth of a single shelf. This allows, for example, a shelf 36 to be mounted to both the front and rear vertical standards 24, 26 at the same vertical height, as shown partially in FIGS. 1 and 5, whereby the inward-most portions or free inner edge of the shelves are in reasonably close proximity, potentially even abutting but preferably spaced slightly apart, in the center of the shelving system. However, it will be appreciated that the shelving system 20 may also include shelves 36 having a variety of different dimensions, including different lengths, widths and/or depths depending on a user's preference and intended use of the system 20 or the objects to be displayed thereon.

As previously mentioned above, for supporting the shelves 36, the inwardly facing surface 56 of the front and rear vertical standards 24, 26 includes a plurality of spaced-apart shelf mounting apertures 58 defined therein, as illustrated in FIG. 4. Preferably, the shelf mounting apertures 58 are pairs of generally elongated apertures vertically spaced along the length of the vertical standard, but the apertures 58 may also be of a variety of other shapes and/or sizes such as square, circular, oval, rectangular or the like.

The shelves are supported by shelf mount brackets 82 at each end of the shelf 36. As seen in FIG. 4, each bracket has a mounting structure 80 at one end for cooperation with the apertures 58. More specifically the illustrated mounting structure includes an upwardly extending tab 80a and two downwardly extending hooks 80b and 80c. The tab and hooks insert into slots as follows. With the bracket 82 upwardly angled, upper tab 80a is inserted into one slot 58. The bracket 82 is then rotated downwardly until hooks 80b and 80c extend into the next two lower slots. The bracket is then slid downwardly so that the edges of the slots 58 are received into the hook recesses 81b and 81c. A portion of tab 80a remains within the vertical standard and braced against the inside surface 56 of U-shaped member 46. This arrangement provides substantial cantilever support for shelf loading.

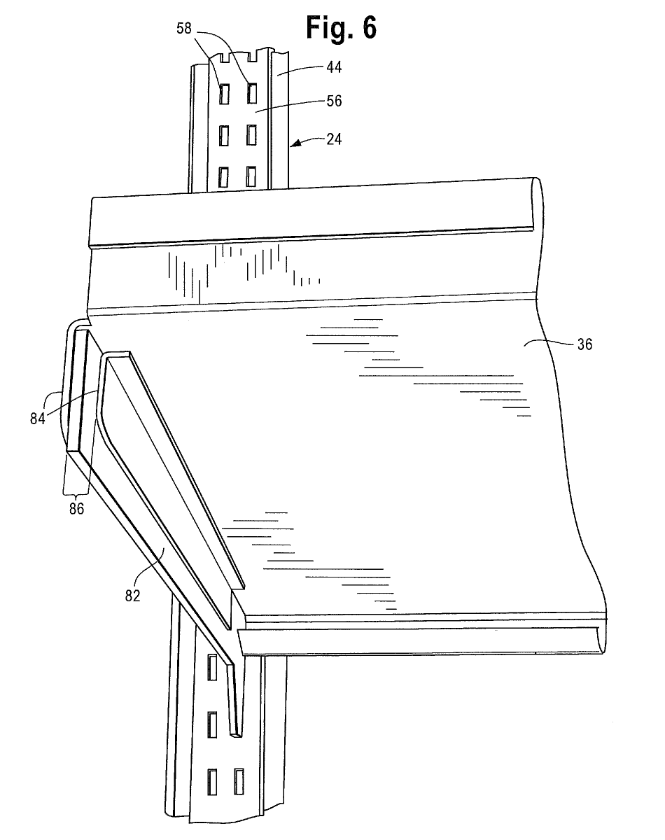

One or more shelves 36 are mounted on and supported by a shelf support bracket 82, as seen in FIG. 6, which bracket 82 is aligned with and mounted on the inward face 56 of a vertical standard. The shelf support bracket 82 may be provided separately from the shelf 36, in which case the bracket is first cantilever mounted to an upright vertical standard 24, 26, and the shelf then mounted onto the bracket, as described in detail below. Alternatively, the shelf support bracket 82 may be integral with or otherwise fixedly attached to the shelf 36, such that the shelf and bracket are reverse cantilever mounted to the vertical standards as a single unit.

As illustrated in FIG. 6, the shelf 36 is supported by the bracket 82. For example, shelf 36 may include one or more mounting surfaces on the underside of the shelf 36 that cooperate with the shelf mounting bracket 82 to securely mount the shelf to the bracket. In one embodiment illustrated in FIG. 6, the shelf includes elongated parallel vertical walls 84 that extend substantially along the entire depth of the shelf, forming a slot therebetween to receive the mounting bracket 82, thereby resisting lateral movement of the shelf. However, the shelf 36 may be mounted to and/or supported by mounting bracket 82 in a variety of other ways. In one non-limiting example, instead of the elongated vertical walls 84 shown in FIG. 6, the ends or underside of the shelf may include one or more surfaces such as extensions or spaced apart tabs (not shown) that are adapted to cooperate with mounting bracket 82 to removably secure the shelf to the shelf support bracket 82. The shelf may also be mounted to the bracket 82 with screws, adhesives, or the like, alone or in combination with the above-mentioned mounting surfaces and structures.

As mentioned above, the illustrated shelf 36 may be reverse cantilever mounted generally horizontally, or parallel to the floor, as illustrated in FIG. 6 and on the right half of the shelving system 20 in FIG. 1. A generally horizontally mounted shelf may be useful, for example, to store and display books, files and the like on edge. As also seen in FIG. 1, however, one or more shelves 36 may also be reverse cantilever mounted from the inward facing surface 56 of the vertical standards 24, 26 at an angle. For example, the shelves on the left half of the shelving system 20 in FIG. 1 are mounted at an angle approximately 45° to the floor, which may be useful to display a variety of other items such as magazines. Depending on the items to be displayed on the shelf, it may also be desirable to reverse cantilever mount the shelves at any number of angles greater or lesser than 45°. A single shelf support bracket 82 may be provided for both horizontal and angled shelf mounting, or alternatively, separate brackets 82 may be provided for the different types of mount.

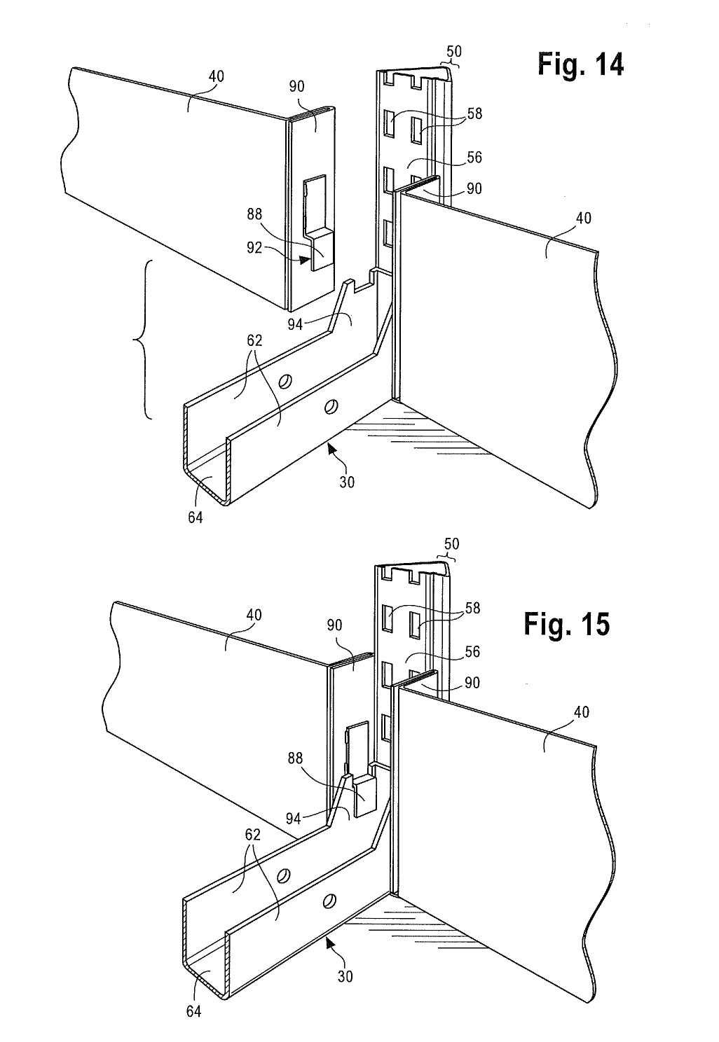

As seen generally in FIG. 1, a base facia or “kick plate” panel 40 extends between the shelving system frames 22 proximal to the base of the shelving system 20. More specifically, as illustrated in FIGS. 14 and 15 a kick plate 40 is mounted to lower horizontal cross rails 30 which, as described above, form part of the shelving system frame 22. Preferably, the kick plate 40 has a mounting surface at each end, that is cooperative with respective mounting surfaces on the lower horizontal cross rails 30 to permit removable mounting of the kick plate panel 40 between the cross rails 30. For example, as illustrated in FIG. 14, the kick plate mounting surface may include an extension or tab 88 that protrudes outwardly and downwardly from an end surface 90 of the kick plate 40. A portion of tab 88 is parallel to end surface 90 of the kick plate 40, forming a channel 92 between the tab 88 and surface 90. Channel 92 fits snugly over a correspondingly shaped surface 94 on the vertical side wall 62 of lower horizontal cross rail 30. The base facia or kick plate panel 40 not only provides an aesthetically pleasing appearance to the shelving system 20, but it also helps to further secure the respective frame structures 22 together. In addition, the base facia or kick plate 40 may also help to prevent objects from being inadvertently dropped or lost beneath the shelving system while also helping to reduce the accumulation of dirt or dust underneath the system 20. It is also easily removed for access and replaced, if necessary, without the disassembly of other components of the shelving system 20.

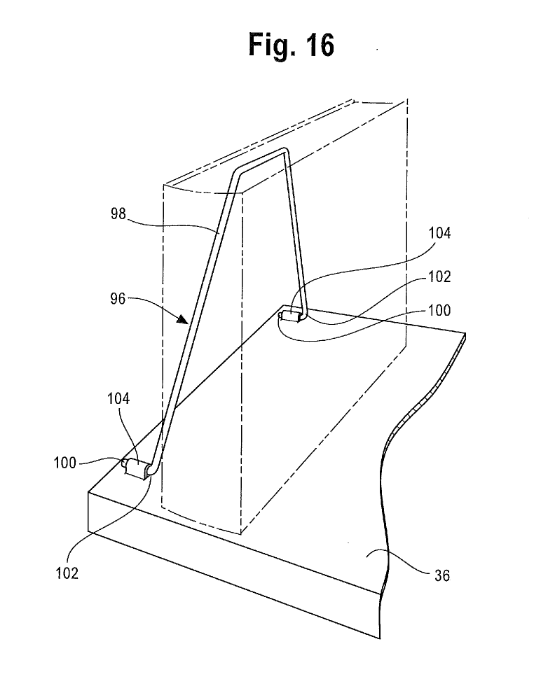

The shelving system 20 may also include optional bookstops, or bookends 96 that can be mounted to the shelves 36. The bookstops 96 can be seen, for example, in FIG. 16. As seen there, the illustrated bookstop 96 is formed by an open wire frame or rod 98 bent into an inverted “U” shape, although it will be appreciated that the rod 98 may be formed into any desired shape or configuration. The terminal ends 100 of the rod 98 include a mounting portion 102. In FIG. 16, the terminal ends 100 of rod 98 are bent to form an “L” shape mounting portion.

In the illustrated shelving system 20, the “L” shaped ends of the rod 98 are inserted into one or more corresponding punch outs or mounting apertures 104 that are integral with the shelf 36 top surface and raised above the shelf top surface. That is, the mounting apertures 104 and the shelf are of one-piece construction, such that the apertures 104 are formed from protrusions or “punch-outs” from the top surface of the shelf 36. In the illustrated embodiment, the integral mounting apertures 104 are elongated and generally cylindrical in shape, but the apertures 104 may also be a variety of other shapes, configurations and/or sizes. The mounting portions 102 of the open rod bookstop 96 are removably insertable in the mounting apertures 104, preferably extending fully through the aperture and bracing against the upper surface of the shelf 36 to securely mount the bookstop 96 to the top surface of shelf 36.

As seen also in FIG. 1, the shelving system 20 may also optionally include an overhead lighting fixture 42 and/or translucent panels. The lighting fixture may be mounted to the horizontal members 32 proximal to the top end of the system and extend outwardly to illuminate the shelf contents and provide additional ambient light to the user. In one embodiment, the shelving system 20 may include translucent top panels also mounted to or resting upon the horizontal members 32a, 32b, and 32c. Such translucent top panels may help to reduce the accumulation of dust or debris on the shelves 36 and to allow ambient lighting to illuminate the shelf contents.

Although described in connection with the preferred and illustrated embodiments, the subject matter is not limited to these embodiments, may be modified in such manner that would be apparent to those skilled in the field, and reference is required to the appended claims for the full scope of the subject matter disclosed herein.

1. A reverse cantilevered shelf mounting system comprising:
1) an upright vertical standard for supporting a plurality of horizontal shelves, the standard having an inwardly facing surface and an outwardly facing surface,
2) a shelf cantilever-supported by the inwardly facing surface and extending inwardly therefrom and terminating at a free inner edge.

2. The reverse cantilevered shelf mounting system of claim 1 wherein the system comprises at least two of such upright vertical standards including an upright front vertical standard and an upright rear vertical standard, and wherein the shelf is cantilever-supported by the inwardly facing surface of the front vertical standard and is free of vertical support by the rear vertical standard.

3. The reverse cantilevered shelf mounting system of claim 2 further comprising a second shelf cantilever supported by the inwardly facing surface of the rear vertical standard, the second shelf being free of vertical support by the front vertical standard.

4. The reverse cantilevered shelf mounting system of claim 3 wherein the first and second shelves each have substantially the same width and depth, and the front and rear vertical standards are horizontally spaced apart by a distance of approximately twice the depth.

5. The reverse cantilevered shelf mounting system of claim 1 wherein the inwardly facing surface of the vertical standard comprises a plurality of spaced-apart shelf mounting apertures defined therein and wherein the shelf comprises a mounting surface cooperative with one or more of the mounting apertures to removably secure the shelf to the vertical standard.

6. A two piece shelf support standard comprising:
a first elongated member and a second elongated member substantially co-extensive with the first elongated member, said first and second members together defining an upright shelf support standard having a generally triangular cross-sectional shape,
wherein the standard has a first surface facing in a first direction and a second surface facing in a direction opposite to the first, and a plurality of shelf mounting apertures defined in the second surface.

7. The shelf support standard of claim 6 wherein the first elongated member defines two sides of a generally triangular cross sectional shape of the standard and the second elongated member defines at least a portion of the remaining side of the generally triangular cross sectional shape.

8. The shelf support standard of claim 7 wherein the first elongated member defines an elongated slot extending in the remaining side, the slot extending along the length of the member, and wherein said second elongated member is mounted within the slot, and the plurality of shelf mounting apertures are defined in the second elongated member.

9. A shelving system comprising:
a first frame structure having a top end and a bottom end,
a second frame structure having a top end and a bottom end,
a first horizontal member extending between the first and second frame structures, proximal to the top end,
a second horizontal member extending between the first and second frame structures, proximal to the bottom end,
a first tension member extends between a first location on the first frame structure to a first location on the second frame structure,
a second tension member extends between a second location on the second frame structure to a second location on the first frame structure,
wherein the first and second locations are vertically spaced, and
wherein the first and second tension members exert tension to securely connect the first and second frame structures together.

10. The shelving system of claim 9 wherein at least one of the first and second tension members has an adjustable length.

11. The shelving system of claim 9 wherein at least one of the first and second tension members is connected to the top end of one of the first and second frame structures proximal to the top end thereof.

12. The shelving system of claim 9 wherein at least one of the first and second tension members is connected to the top end of one of the first and second frame structures proximal to the bottom end thereof.

13. A bookshelf and bookstop combination comprising:
a one-piece shelf comprising a top surface and a first raised mounting aperture defined above the surface, and
a bookstop defined by an open wire frame wherein a mounting portion of the wire frame is removably receivable within the mounting aperture to secure the bookstop to the shelf.

14. The bookshelf and bookstop combination of claim 13 wherein the shelf further comprises a second raised mounting aperture defined above the top surface, and wherein the bookstop wire frame comprises a first end and a second end, each of the first and second ends being removably receivable by the respective first and second raised mounting apertures to secure the bookstop to the shelf.

15. The bookshelf and bookstop combination of claim 13 wherein the bookstop wire frame comprises a book engaging portion and the mounting portion extends substantially perpendicularly to the book engaging portion.

16. A shelving system comprising:
a pair of spaced-apart front vertical shelf support standards,
a pair of spaced-apart rear vertical shelf support standards,
a pair of cross rails, each cross rail extending between and connecting a front standard and a rear standard proximal to a lower end of the standards,
a fascia panel having a first end and a second end for mounting between the front vertical standards proximal to the lower end of the vertical standards,
the panel having a mounting surface at each end, and
each of the cross rails being cooperative with the respective mounting surfaces for permitting removable mounting of the panel between the cross rails.

17. The shelving system of claim 16 wherein each of the cross rails comprises a generally U-shaped cross-sectional shape having parallel vertical side walls.

18. The shelving system of claim 17 wherein at least one of the side walls is adapted to cooperate with a mounting surface for removably securing the panel to the cross rail.

19. The shelving system of claim 18 wherein the mounting surface comprises a slot to receive a portion of the respective cross rail.
